(19) United States
(12) Patent Application Publication
(10) Pub. No.: US 2020/0376825 A1
(43) Pub. Date: Dec. 3, 2020

(54) SEPARATION APPARATUS

(71) Applicant: AGC Inc., Chiyoda-ku (JP)

(72) Inventors: Tateo BABA, Tokyo (JP); Kouji KOITABASHI, Tokyo (JP)

(73) Assignee: AGC Inc., Chiyoda-ku (JP)

(21) Appl. No.: 16/506,685

(22) Filed: Jul. 9, 2019

(30) Foreign Application Priority Data
Jun. 3, 2019 (JP) 2019-103908

(51) Int. Cl. B32B 43/00

(52) U.S. Cl. CPC B32B 43/006

(57) ABSTRACT

A separation apparatus for separating a first plate from a laminate formed by laminating the first plate, an adhesive layer, and a second plate in this order is provided. The separation apparatus includes a base configured to flatly support the first plate from below, a blade configured to be inserted between the first plate and the adhesive layer and to advance in parallel to a support surface of the base, a limiting member configured to support the adhesive layer from below and to limit contact between the adhesive layer and the blade, the limiting member being behind a blade tip, and an interlocking mechanism configured to cause the limiting member to advance in conjunction with the blade.

### CROSS-REFERENCE TO RELATED APPLICATIONS

This application is based on and claims priority to Japanese Patent Application No. 2019-103908, filed on Jun. 3, 2019, the entire contents of which are incorporated herein by reference.

### BACKGROUND OF THE INVENTION

### 1. Field of the Invention

The disclosures herein relate to a separation apparatus.

### 2. Description of the Related Art

Conventionally, a first plate and a second plate may be bonded together through an adhesive layer. For example, the second plate is a display device that displays images. Examples of the display device include a liquid crystal display, an organic electro-luminescence (EL) display, and a plasma display. Further, the first plate is a transparent plate that protects the image display surface of the display device. The display device may be bonded to the transparent plate through the adhesive layer before shipment. Alternatively, the display device may be bonded to a window glass, which is the transparent plate, through the adhesive layer after shipment. The user sees an image displayed on the display device through the transparent plate and the transparent adhesive layer.

After the transparent plate and the display device are bonded through the adhesive layer, the transparent plate and the display device may be required to be separated, for the purpose of replacing the transparent plate or the display device with a new one, or removing the display device, which becomes no longer necessary, from the window glass. However, because the adhesive layer is applied to prevent dislocation and falling, it is not easy to separate the transparent plate and the display device. If an excessive force is applied at the time of separation, the transparent plate or the display device may be damaged.

Patent Document 1 describes a method for separating a transparent plate and a display device bonded through an adhesive layer by introducing ions into the adhesive layer. In this method, a laminate is immersed in an aqueous solution containing ions, and ions are introduced from the side surfaces where the adhesive layer is exposed.

However, in the method described in Patent Document 1, ions are not sufficiently introduced around the center of the adhesive layer, thus resulting in poor separation performance. As the area of the adhesive layer increases, separation performance decreases.

Further, in the method described in Patent Document 1, the adhesive layer partially remains on the surfaces of both the transparent plate and the display device. Therefore, when the transparent plate and the display device are reused after being separated, it is required to remove the adhesive layer remaining on the surfaces, which would be troublesome.

Further, in the method described in Patent Document 1, the adhesive layer is required to include a compound that can form a complex with ions. Therefore, adhesive layers that can be adopted are limited.

Patent Document 2 describes a separation apparatus for separating a display unit, in which a transparent plate and a display device are bonded through an adhesive layer, into the transparent plate and the display device. The separation apparatus includes a metal plate that cuts the adhesive layer in parallel to the image display surface of the display device. The metal plate has a thickness smaller than that of the adhesive layer, and the adhesive layer is cut at the center in the thickness direction of the adhesive layer.

It is contemplated that, in order to separate a first plate and a second plate bonded through an adhesive layer, the tip (front end) of a blade is inserted between the first plate and the adhesive layer or between the second plate and the adhesive layer, and then the blade is advanced. In this case, the blade is interposed and pressed between the second plate and the first plate, and the advancement of the blade may be hindered.

### RELATED-ART DOCUMENTS

### Patent Documents

Patent Document 1 is Japanese Laid-open Patent Publication No. 2015-178068, and

Patent Document 2 is Japanese Laid-open Patent Publication No. 2016-38436.

### SUMMARY OF THE INVENTION

According to at least one embodiment, a technology that reduces resistance force exerted on a blade during advancement of the blade is provided.

According to at least one embodiment, a separation apparatus for separating a first plate from a laminate formed by laminating the first plate, an adhesive layer, and a second plate in this order is provided. The separation apparatus includes a base configured to flatly support the first plate from below, the second plate being disposed above the first plate; a blade configured to be inserted between the first plate and the adhesive layer, and to advance in parallel to a support surface of the base that supports the first plate; a limiting member configured to support the adhesive layer from below and to limit contact between the adhesive layer and the blade, the limiting member being behind a blade tip that is a front end of the blade; and an interlocking mechanism configured to cause the limiting member to advance in conjunction with the blade.

According to at least one embodiment, a separation apparatus for separating a second plate from a laminate formed by laminating a first plate, an adhesive layer, and the second plate in this order is provided. The separation apparatus includes a base configured to flatly support the first plate from below, the second plate being disposed above the first plate; a blade configured to be inserted between the second plate and the adhesive layer, and to advance in parallel to a support surface of the base that supports the first plate; a limiting member configured to support the second plate from below and to limit contact between the second plate and the blade, the limiting member being behind a blade tip that is a front end of the blade; and an interlocking mechanism configured to cause the limiting member to advance in conjunction with the blade.

### BRIEF DESCRIPTION OF THE DRAWINGS

Other objects and further features of the present invention will be apparent from the following detailed description when read in conjunction with the accompanying drawings, in which:

FIG. 1 is a diagram illustrating a laminate to be separated by a separation apparatus according to an embodiment;

FIG. 2A is a diagram illustrating the separation apparatus according to the embodiment when viewed in the Y-axis direction;

FIG. 2B is a diagram illustrating the separation apparatus of FIG. 2A when viewed in the Z-axis direction;

FIG. 3 is a cross-sectional view of a blade unit according to the embodiment;

FIG. 4A is a diagram illustrating an operation of the separation apparatus according to the embodiment;

FIG. 4B is a diagram illustrating an example of operation performed following FIG. 4A;

FIG. 4C is a diagram illustrating an example of operation performed following FIG. 4B;

FIG. 5 is a diagram illustrating a positional relationship between blades, first rollers, second rollers, and third rollers according to the embodiment;

FIG. 6 is a cross-sectional view of a first roller according to the embodiment;

FIG. 7A is an enlarged view of a part of the separation apparatus illustrated in FIG. 2A; and

FIG. 7B is an enlarged view of a part of the separation apparatus illustrated in FIG. 2B.

### DESCRIPTION OF THE EMBODIMENTS

According to at least one embodiment, it is possible to reduce resistance force exerted on a blade during advancement of the blade.

In the following, embodiments of the present invention will be described with reference to the accompanying drawings. In the drawings, the same or corresponding elements are denoted by the same reference numerals, and a description thereof may be omitted. Further, in the drawings, the X-axis direction, the Y-axis direction, and the Z-axis direction are perpendicular to each other. The X-axis direction and the Y-axis direction are parallel to a support surface 21 that supports a transparent plate 2 of a base 20. The X-axis direction is a moving direction of blades 31, the positive X-axis direction is a forward direction, and the negative X-axis direction is a backward direction. The Y-axis direction is a horizontal direction. The Z-axis direction is a direction perpendicular to the support surface 21.

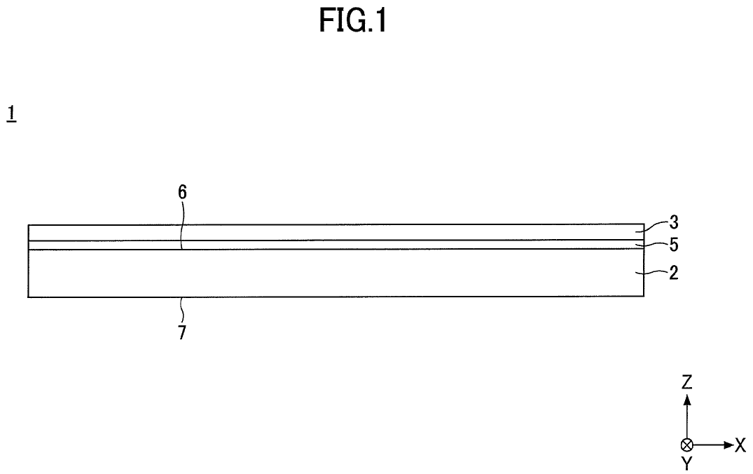

FIG. 1 is a diagram illustrating a laminate to be separated by a separation apparatus according to an embodiment of the present invention. A laminate 1 is formed by bonding the transparent plate 2 and a display device 3 through an adhesive layer 5. The laminate 1 is formed by laminating the transparent plate 2, the adhesive layer 5, and the display device 3 in this order. When viewed in the Z-axis direction, the transparent plate 2 has the same size as the adhesive layer 5 and the display device 3, but may have a different size from the adhesive layer 5 and the display device 3. When viewed in the Z-axis direction, one of the transparent plate 2 and the display device 3 may be larger than the other.

In the present embodiment, the transparent plate 2 corresponds to a first plate described in the claims, and the display device 3 corresponds to a second plate described in the claims. The first plate and the second plate may be any members formed in plate shapes. For example, the first plate may be the display device 3, and the second plate may be the transparent plate 2.

The transparent plate 2 is, for example, a protective panel that protects the image display surface of the display device 3. The transparent plate 2 may have a larger thickness than that of the display device 3. Accordingly, the transparent plate 2 does not readily deform as compared to the display device 3. The transparent plate 2 has a rectangular shape when viewed in the Z-axis direction, and has two long sides parallel to the X-axis direction and two short sides parallel to the Y-axis direction.

The transparent plate 2 has a first main surface 6 facing the display device 3 and a second main surface 7 facing the side opposite to the display device 3. The first main surface 6 of the transparent plate 2 is bonded to the image display surface of the display device 3 through the transparent adhesive layer 5. The display device 3 may be bonded to the transparent plate 2 through the adhesive layer 5 before shipment. Alternatively, the display device 3 may be bonded to a window glass, which is an example of the transparent plate 2, through the adhesive layer 5 after shipment. The user sees the screen of the display device 3 through the transparent plate 2 and the transparent adhesive layer 5.

A light blocking layer may be formed on the first main surface 6 of the transparent plate 2 to cover wiring of the display device 3 so that the wiring cannot be seen by the user. When viewed from the user, the light blocking layer is formed in a frame shape, and the inner periphery of the light blocking layer overlaps with the outer periphery of an image display area of the display device 3. Further, a metal layer that functions as a mirror may be formed on the first main surface 6 of the transparent plate 2.

Further, a functional layer such as a low reflection layer or an antifouling layer may be formed on the second main surface 7 of the transparent plate 2. Only one of the low reflection layer and the antifouling layer may be formed, or both of the low reflection layer and the antifouling layer may be formed. In the latter case, the low reflection layer is formed on the second main surface 7 of the transparent plate 2, and the antifouling layer is formed on the low reflection layer.

The low reflection layer prevents the reflection of external light. The low reflection layer has a structure in which, for example, multiple layers having different refractive indices are stacked. The low reflection layer improves anti-glare properties for reducing the reflection of external light, thereby enhancing the visibility of an image displayed on the display device 3.

The antifouling layer reduces the adhesion of fouling. If the display device 3 is a touch panel, the antifouling layer reduces the adhesion of fingerprints. The antifouling layer may be formed of a fluorine-containing organosilicon compound. The fluorine-containing organosilicon compound has properties such as antifouling properties, water-repellency, and oil-repellency.

Further, the second main surface 7 of the transparent plate 2 may have an uneven surface that diffuses and reflects external light such as sunlight and illumination light. The uneven surface improves anti-glare properties for reducing the reflection of external light, thereby enhancing the visibility of an image displayed on the display device 3. The uneven surface may be formed by an etching process. The low reflection layer and the antifouling layer may be formed on the uneven surface.

The transparent plate 2 may be formed of inorganic glass such as soda-lime glass, aluminosilicate glass, aluminoborosilicate glass, or alkali-free glass. The inorganic glass may be strengthened glass in terms of improved strength. The strengthened glass may be chemically strengthened glass or thermally strengthened glass.

The chemically strengthened glass is formed of glass containing alkali metal, and more specifically is formed of soda-lime glass, aluminosilicate glass, or the like. The chemically strengthened glass has a compressive stress layer formed on the glass surface through ion exchange of alkali metal ions (such as Na ions) having a small ionic radius in the glass surface with alkali metal ions having a larger ionic radius.

The transparent plate 2 may be formed of organic glass such as polycarbonate resin or acrylic resin. Further, the transparent plate 2 may be laminated glass in which multiple glass plates are bonded together.

The display device 3 has a rectangular shape when viewed in the Z-axis direction, and has two long sides parallel to the X-axis direction and two short sides parallel to the Y-axis direction. The display device 3 is, for example, a liquid crystal display. The liquid crystal display includes a liquid crystal panel and a backlight, and displays an image by controlling, for each pixel, the transmittance of light transmitted through the liquid crystal panel.

The liquid crystal panel includes, for example, an array substrate, a liquid crystal layer, and a color filter substrate in this order. The array substrate includes, on the liquid crystal layer side, a switching element such as a thin-film transistor (TFT) and a transparent pixel electrode. The color filter substrate includes, on the liquid crystal layer side, a color filter and a transparent counter electrode.

The liquid crystal panel includes a first polarizing plate disposed on the side of the array substrate opposite to the liquid crystal layer, and a second polarizing plate disposed on the side of the color filter substrate opposite to the liquid crystal layer. The polarization axis of the first polarizing plate and the polarization axis of the second polarizing plate intersect at an angle of 90°, for example.

The backlight illuminates the liquid crystal panel from the side opposite to the image display surface of the liquid crystal panel. The backlight may be an edge-lit backlight or a direct-lit backlight. The backlight may have various types of optical films in addition to light emitting elements. The optical films make uniform the intensity of light, change the angle of view, and improve utilization efficiency of light, for example.

The display device 3 may include a touch sensor. The touch sensor detects an object such as a user's finger touching or approaching the transparent plate 2. The display device 3 may include a frame or a case that supports the liquid crystal panel and the backlight. The display device is not limited to the liquid crystal display, and may be an organic EL display, a plasma display, an electronic paper, or an LED display, for example.

The adhesive layer 5 bonds the transparent plate 2 and the display device 3 together. The adhesive layer 5 may be formed of a material known in the art of display devices. Typically, the adhesive layer 5 is formed of a cured material of a curable resin composition. The adhesive layer 5 may have a single layer structure or a multi-layer structure. If the adhesive layer 5 has a multi-layer structure, the same material may be stacked or different materials may be stacked. In addition, the number of layers constituting the adhesive layer 5 may be two or more.

The storage elastic modulus G′ of the adhesive layer 5 at a frequency of 1 Hz and 25° C. is preferably 5×10² Pa or more, and more preferably 1×10³ Pa or more. If the storage elastic modulus G′ is 5×10² Pa or more, the adhesive layer 5 has sufficient stiffness. Thus, the blades 31, which will be described below, can be inserted between the adhesive layer 5 and the transparent plate 2 without breaking the adhesive layer 5. Also, the blades 31 can stably move along the peeling interface. Further, the storage elastic modulus G′ is preferably 1×10⁷ Pa or less, and more preferably 1×10⁶ Pa or less. Even if air bubbles are formed at the interface between the display device 3 and the adhesive layer 5 or at the interface between the transparent plate 2 and the adhesive layer 5 when the transparent plate 2 and the display device 3 are bonded together, the air bubbles tend to disappear in a short period of time if the storage elastic modulus G′ is 1×10⁷ Pa or less. Further, because the adhesive layer 5 is relatively soft, the blades 31 can be readily inserted between the adhesive layer 5 and the transparent plate 2 from a separation start point. In addition, the adhesive layer 5 has high tensile elongation. Thus, when the adhesive layer 5 is pulled and separated from the display device 3 after the separation of the transparent plate 2 from the adhesive layer, the adhesive layer 5 will not be readily torn off and the entire adhesive layer 5 can be peeled off.

If the adhesive layer 5 has a multi-layer structure, the storage elastic modulus G′ of each of a plurality of layers constituting the multi-layer structure is preferably 5×10² Pa or more, and more preferably 1×10³ Pa or more. Further, if the adhesive layer 5 has a multi-layer structure, the storage elastic modulus G′ of each of the plurality of layers constituting the multi-layer structure is preferably 1×10⁷ Pa or less, and more preferably 1×10⁶ Pa or less.

The gel fraction of the adhesive layer 5 is preferably greater than or equal to 1% and less than or equal to 50%, and more preferably greater than or equal to 10% and less than or equal to 40%. If the gel fraction of the adhesive layer 5 is greater than or equal to 1%, the adhesive layer 5 has higher heat resistance. If the gel fraction of the adhesive layer 5 is less than or equal to 50%, the adhesive layer 5 has excellent conformability to uneven surfaces, which may be formed between the adhesive layer 5 and the display device 3 or the transparent plate 2 when the display device 3 and the transparent plate 2 are bonded together through the adhesive layer 5, thus allowing air bubbles not to be readily formed.

The gel fraction of the adhesive layer 5 is measured by the following measurement method. Two 60 mm per-side square polyethylene terephthalate (PET) mesh films are prepared, and a 50 mm per-side square adhesive layer (mass A) is inserted between the two mesh films. In order to prevent the leakage of the adhesive layer, the peripheries of the two mesh films are stapled. The adhesive layer is immersed in toluene for 1 day, after which the toluene is replaced with new toluene. After this step is repeated twice, the mass (mass B) of the adhesive layer containing toluene is measured. The gel-like adhesive layer containing the toluene is sufficiently dried by heating, and the mass (mass C) of the adhesive layer is measured again. The gel fraction is calculated based on the ratio (100×C/A) of the mass A (the initial mass) to the mass C (the amount of gel after drying).

Preferably, the area of the main surface of the adhesive layer 5 is 10,000 mm² or more, and more preferably 5,000 mm² or more. As the area of the main surface of the adhesive layer 5 increases, the contact area between the adhesive layer 5 and the display device 3 or the contact area between the adhesive layer 5 and the transparent plate 2 increases. Thus, the usefulness of a separation apparatus 10 according to the present embodiment increases. The upper limit of the area of the main surface of the adhesive layer 5 may be 1,000,000 mm², but is not particularly limited thereto.

The thickness of the adhesive layer 5 is preferably 0.2 mm or more, more preferably, greater than or equal to 0.3 mm and less than or equal to 1.5 mm, and even more preferably, greater than or equal to 0.5 mm and less than or equal to 1.0 mm. If the thickness of the adhesive layer 5 is 0.2 mm or more, excessive deformation of the display device due to the insertion of the blades 31 can be prevented, which is preferable. Further, when the adhesive layer 5 is pulled and separated from the display device 3 after the separation of the transparent plate 2 from the adhesive layer 5, the adhesive layer 5 will not be readily torn off while being peeled off. If the thickness of the adhesive layer 5 is 1.5 mm or less, the display device 3 can be appropriately deformed in a separation process, and the blades 31 can be readily inserted between the adhesive layer 5 and the transparent plate 2 from a separation start point without breaking the adhesive layer 5.

The adhesive layer 5 may be obtained by curing a photocurable resin composition, a thermosetting resin composition, or a photocurable and thermosetting resin composition, for example. Such a curable resin composition may be preliminarily cured, formed in a sheet shape, and inserted between the display device 3 and the transparent plate 2.

The term “photocurable resin composition” refers to a resin composition that can be cured by exposure to light. The term “thermosetting resin composition” refers to a resin composition that can be cured by heating. The term “photocurable and thermosetting resin composition” refers to a resin composition that can be cured by exposure to light and heating. Exposure to light means irradiation of light such as ultraviolet light.

The photocurable resin composition is preferably used as a curable resin composition because the photocurable resin composition can be cured at a low temperature and at a high speed.

The photocurable resin composition is preferably a non-solvent type resin composition because the non-solvent type does not require heating to remove a solvent. The term “non-solvent type” means that no solvent is contained or the content ratio of a solvent to the total mass (100 mass %) of the photocurable resin composition is 5 mass % or less. The “solvent” means a liquid (a volatile diluent) with a boiling point of 150° C. or less.

Preferably, the photocurable resin composition does not contain a solvent, such that no drying step is required, and thus, time and energy can be minimized.

The curable resin composition typically includes a curable compound (A) having curable groups and a photoinitiator (B). A non-curable component other than the photoinitiator (B) may be included as appropriate. Examples of the non-curable component include a non-curable polymer (C), a chain transfer agent (D), and other additives.

Examples of the curable compound (A) include an acrylic-based compound, a silicone-based compound, a urethane acrylate-based compound, and an epoxy-based compound. For readily adjusting the storage elastic modulus G′ of the adhesive layer 5 within a range greater than or equal to 5×10² Pa and less than or equal to 1×10⁷ Pa, the curable compound (A) is preferably a silicone-based compound or a urethane-acrylate-based compound. Further, for readily adjusting the gel fraction of the adhesive layer 5 within a range greater than or equal to 1% and less than or equal to 50%, the curable compound (A) is more preferably a urethane acrylate-based compound.

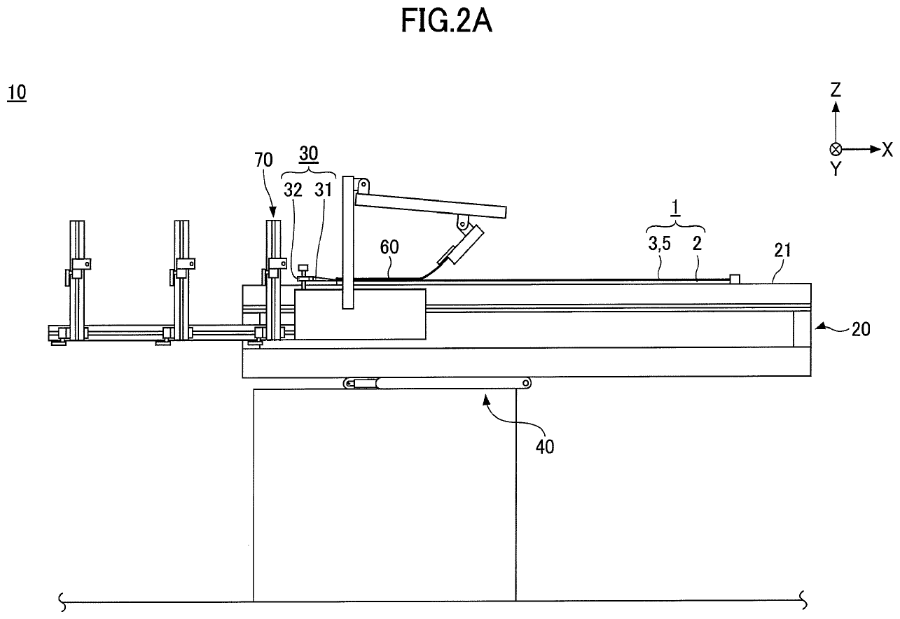

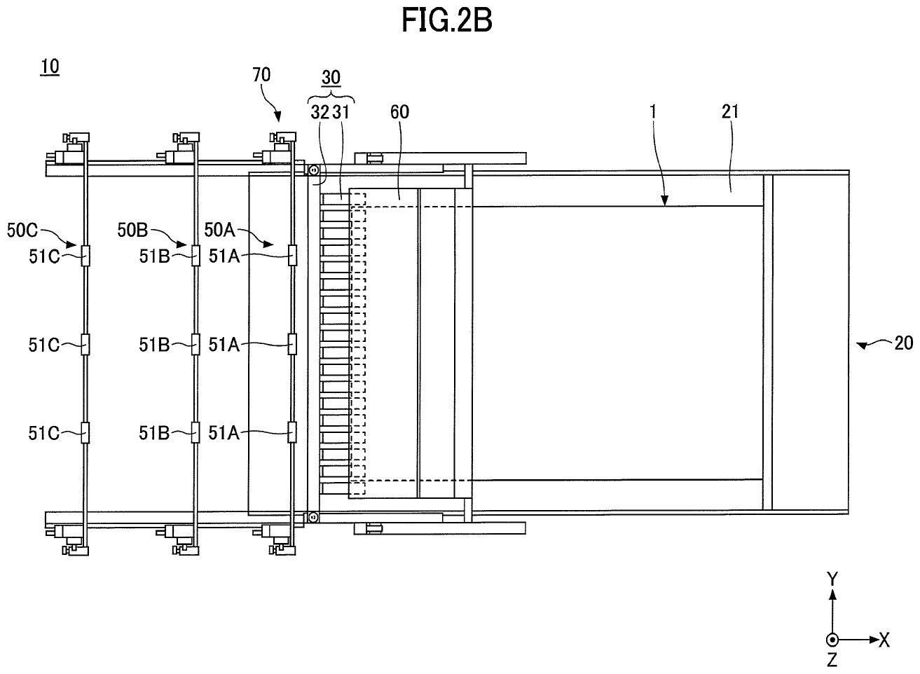

FIG. 2A is a diagram illustrating the separation apparatus according to the embodiment when viewed in the Y-axis direction. FIG. 2B is a diagram illustrating the separation apparatus of FIG. 2A when viewed in the Z-axis direction. The separation apparatus 10 separates the laminate 1 such that the transparent plate 2 is separated from the display device 3 and the adhesive layer 5. Approximately no residue of the adhesive layer 5 remains on the transparent plate 2 after separation. Thus, the residue can be readily removed.

The separation apparatus 10 includes, for example, the base 20, a blade unit 30, a tilt angle adjustment mechanism 40, first rollers 51A, second rollers 51B, third rollers 51C, a heater 60, and an interlocking mechanism 70. In the present embodiment, as illustrated in FIG. 2B, the first rollers 51A, the second rollers 51B, and the third rollers 51C are arranged at intervals in the X-axis direction; however, the number of rollers arranged at intervals in the X-axis direction is not limited to three, and may be one or may be four or more.

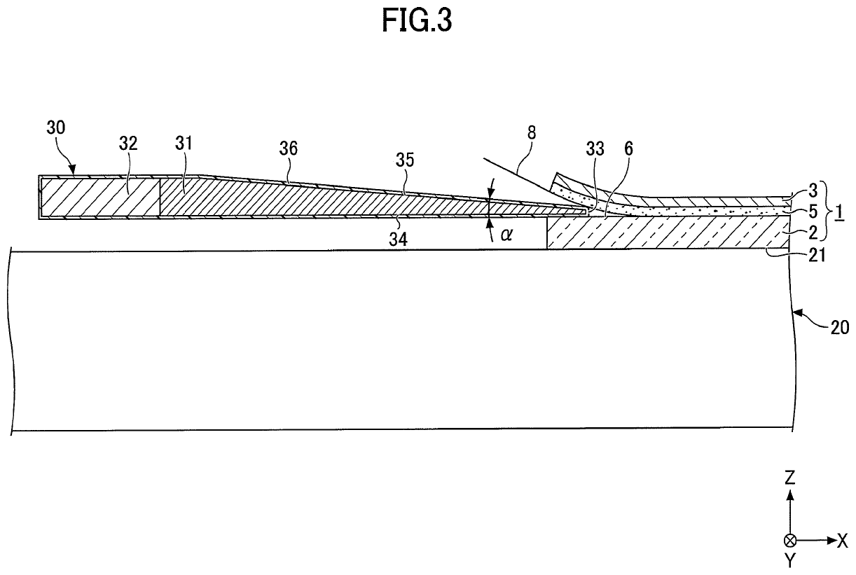

As illustrated in FIG. 3, the base 20 has the support surface 21 that flatly supports the transparent plate 2 from below, with the display device 3 being disposed above the transparent plate 2. The transparent plate 2, the adhesive layer 5, and the display device 3 are disposed on the support surface 21 in this order. The base 20 continues to flatly support the transparent plate 2 while the display device 3 is separated from the transparent plate 2, thereby minimizing damage to the transparent plate 2. The base 20 is merely for the purpose of having the transparent plate 2 mounted thereon, and is not intended to adsorb the transparent plate 2. However, the base 20 may adsorb the transparent plate 2.

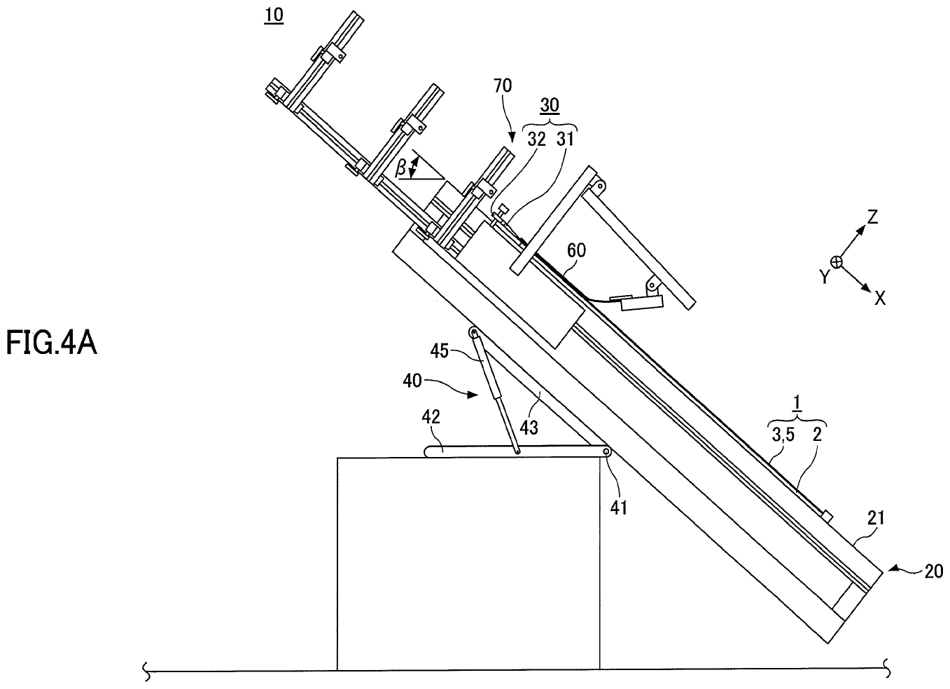

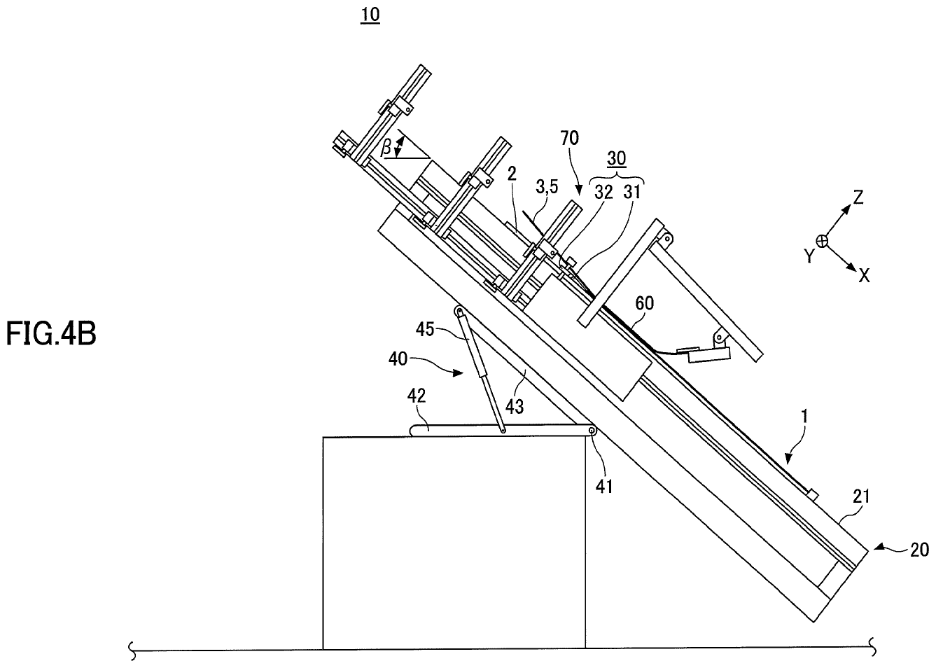

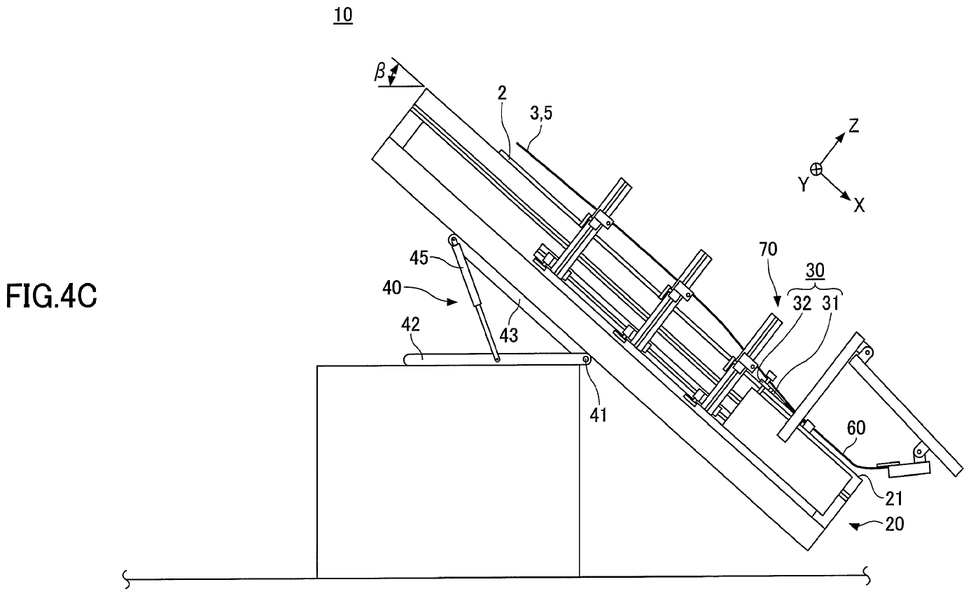

FIG. 3 is a cross-sectional view of the blade unit according to the embodiment. The blade unit 30 includes the blades 31 and a blade holder 32. The blades 31 are inserted between the transparent plate 2 and the adhesive layer 5 or between the adhesive layer 5 and the display device 3. In the following, an example in which the blades 31 are inserted between the transparent plate 2 and the adhesive layer 5 will be described. A shim plate 8, which is thinner than a blade tip 33 of each of the blades 31, is inserted between the transparent plate and the adhesive layer 5, and forms a gap. The blade tip 33 of each of the blades 31 is inserted into the gap. After the shim plate 8 inserted between the transparent plate 2 and the adhesive layer 5 is removed, the tilt angle adjustment mechanism 40 tilts the base 20 from the horizontal state as illustrated in FIG. 2A to the tilt state (in which the base 20 is inclined forward and downward) as illustrated in FIG. 4A. The blades 31 are advanced by gravity.

Each of the blades 31 has a parallel surface 34, which is a first surface, and an inclined surface 35, which is a second surface. The parallel surface 34 is approximately parallel to or slightly inclined relative to the support surface 21 of the base 20, and makes line contact with the first main surface 6 of the transparent plate 2. The inclined surface 35 is inclined relative to the parallel surface 34, and the parallel surface 34 is joined to the inclined surface 35 at the blade tip 33. When viewed in the Y-axis direction, an angle formed by the parallel surface 34 and the inclined surface 35 is also referred to as a blade tip angle α. The blade tip angle α may be greater than or equal to 1° and less than or equal to 60°, for example.

The inclined surface 35 may come into contact with the adhesive layer 5. Therefore, the inclined surface 35 is roughened so as to reduce adherence to the adhesive layer 5. Examples of a roughening method include shot blasting, polishing, etching, sputtering, vapor deposition, and discharge treatment. The surface roughness Ra of the inclined surface 35 may be 0.7 μm or more, for example. Surface roughness Ra is arithmetic average roughness defined by Japanese Industrial Standards (JIS B0601:2013). If the surface roughness Ra of the inclined surface 35 is 0.5 μm or more, the adherence of the blades 31 to the adhesive layer 5 can be reduced, thus allowing the blades 31 to advance smoothly. Preferably, the surface roughness Ra of the inclined surface 35 may be 0.8 μm or more. Further, in terms of workability, the surface roughness Ra of the inclined surface 35 may be 50 μm or less.

As described above, the inclined surface 35 may come into contact with the adhesive layer 5. Therefore, a coating film 36 may be formed on the inclined surface 35. The coating film 36 is formed of a material having a water contact angle greater than that of a material of the blades 31, thus improving the removability of the blades 31 from the adhesive layer 5. Accordingly, the blades 31 can advance smoothly. For example, the blades 31 are formed of a material such as metal or ceramic. Further, the coating film 36 is formed of a material such as silicone-based resin or fluorine-based resin, for example.

The thickness of the coating film 36 may be greater than or equal to 2 μm and less than or equal to 200 μm, for example. If the thickness of the coating film 36 is 2 μm or more, the coating film 36 is not readily torn, and thus has good durability. Further, if the thickness of the coating film 36 is 200 μm or less, the surface of the coating film 36 conforms to the roughened inclined surface 35. Thus, the coating film 36 has the same surface roughness Ra as that of the inclined surface 35.

Preferably, the surface of each of the blades 31 is entirely roughened and coated; however, at least a part of the surface of each of the blades 31 that comes into contact with the adhesive layer 5 may be roughened and coated. Namely, if the blades 31 are inserted between the transparent plate 2 and the adhesive layer 5 as illustrated in FIG. 3, at least the inclined surface 35 of each of the blades 31 may be roughened and coated. If the blades 31 are inserted between the adhesive layer 5 and the display device 3, at least the parallel surface 34 of each of the blades 31 may be roughened and coated. In addition, the blade holder 32 may also be roughened and coated as illustrated in FIG. 3. This is because the blade holder 32 may come into contact with the adhesive layer 5, as with the blades 31.

As illustrated in FIG. 2B, the plurality of blades 31 are arranged at intervals in the Y-axis direction, and the blade holder 32 holds the plurality of blades 31. The blade unit 30 is arranged in a comb teeth shape. As neighboring blades 31 are spaced apart from each other, only a part of the adhesive layer 5 in the Y-axis direction makes contact with the blades 31. Accordingly, resistance force exerted by the adhesive layer 5 on the blades 31 during advancement can be reduced. Note that greater than or equal to 10% and less than or equal to 50% of the whole adhesive layer 5 in the Y-axis direction may make contact with the blades 31.

The blade unit 30 is not required to be arranged in the comb teeth shape, and may be configured by a single blade 31. In such a case, a part of the single blade 31 extending greater than or equal to 1 mm or less than or equal to 30 mm from a blade tip 33 may contact the adhesive layer 5.

A driving force such as a motor may be used to advance the blades 31. In the present embodiment, gravity is utilized. In this case, a weight may be removably attached to the blades 31. As the total weight of the blades 31 and other components that advance together with the blades 31 increases, the driving force that advances the blades 31 increases.

FIG. 4A is a diagram illustrating operation of the separation apparatus according to the embodiment. FIG. 4B is a diagram illustrating an example of operation performed following FIG. 4A. FIG. 4C is a diagram illustrating an example of an operation performed following FIG. 4B. The tilt angle adjustment mechanism 40 adjusts a tilt angle β of the support surface 21 relative to the horizontal plane. When the support surface 21 is parallel to the horizontal plane, the tilt angle β is 0°, and when the support surface 21 is perpendicular to the horizontal plane, the tilt angle β is 90°. As the tilt angle β increases, a component of the force of gravity in the X-axis direction increases and the driving force that advances the blades 31 also increases.

The tilt angle adjustment mechanism 40 includes a pin 41, which is a rotational center line of the base 20. The pin 41 is disposed in parallel to the Y-axis direction. Further, the tilt angle adjustment mechanism 40 includes a first link 42 and a second link 43. The first link 42 is horizontally fixed, and the second link 43 is fixed to the base 20. The pin 41 allows the second link 43 to be rotatably coupled to the first link 42. An angle formed by the first link 42 and the second link 43 is the tilt angle β.

The tilt angle adjustment mechanism 40 includes an extension cylinder 45, which is used as a driving source for rotating the second link 43. The extension cylinder 45 may be a fluid pressure cylinder such as a hydraulic cylinder or a pneumatic cylinder. One end of the extension cylinder 45 is rotatably coupled to the first link 42, and the other end of the extension cylinder 45 is rotatably coupled to the second link 43. The tilt angle β changes in accordance with the extension and retraction of the extension cylinder 45. After the tilt angle adjustment mechanism 40 adjusts the tilt angle the tilt angle β is fixed.

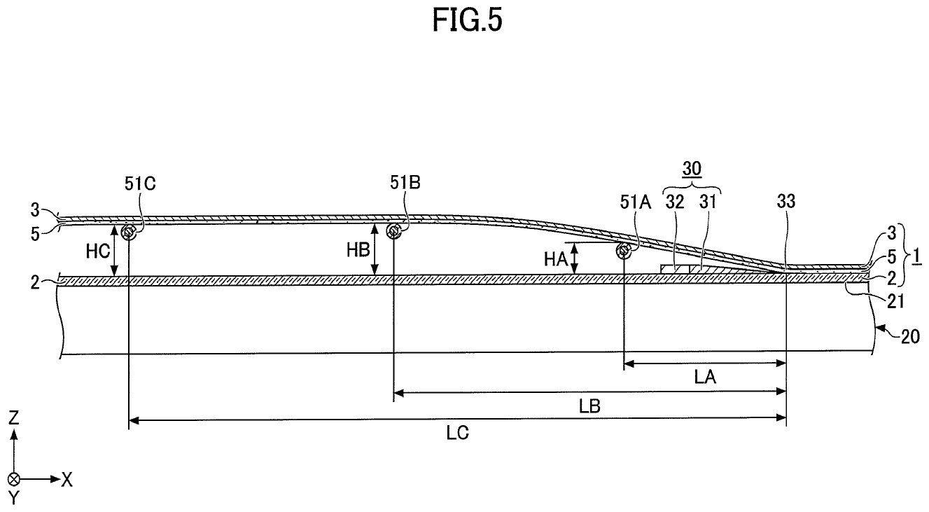

FIG. 5 is a diagram illustrating a positional relationship between the blades, the first rollers, the second rollers, and the third rollers according to the embodiment. The first rollers 51A are examples of limiting members that support the adhesive layer 5 from below so as to limit the contact between the blades 31 and the adhesive layer 5; the first rollers 51A are behind the blade tips 33, which are the front ends of the respective blades 31.

Because the first rollers 51A advance in conjunction with the blades 31, the deformation of the display device 3 and of the adhesive layer 5 due to their own weights can be maintained constant from the blade tips 33 to the first rollers 51A. As a result, the display device 3 with the adhesive layer 5 and the transparent plate 2 are opened in a wedge-shape manner, thus reducing resistance force exerted by the adhesive layer 5 on the blades 31 during advancement. Further, the contact between the adhesive layer 5 and the blades 31 can be constantly limited, thus reducing resistance force exerted by the adhesive layer 5 on the blades 31 during advancement.

Further, unlike the adhesive layer 5, the transparent plate 2 does not have adhesiveness. Thus, resistance force (such as frictional resistance) exerted by the transparent plate 2 on the blades 31 during advancement is negligibly small, as compared to resistance force exerted by the adhesive layer 5 on the blades 31 during advancement.

If the blades 31 are inserted between the adhesive layer 5 and the display device 3, the first rollers 51A are used as limiting members that support the display device 3 from below so as to limit the contact between the display device 3 and the blades 31; the first rollers 51A are behind the blade tips 33, which are the front ends of the respective blades 31. Because the first rollers 51A advance in conjunction with the blades 31, the deformation of the display device 3 due to its own weight can be maintained constant from the blade tips 33 to the first rollers 51A. As a result, the display device 3 with the adhesive layer 5 and the transparent plate 2 are opened in a wedge-shape manner, thus reducing resistance force exerted by the adhesive layer 5 on the blades 31 during advancement.

As illustrated in FIG. 2B, the plurality of first rollers 51A are arranged at intervals in the Y-axis direction, and the plurality of first rollers 51A forms a first roller group 50A. As neighboring first rollers 51A are spaced apart from each other, only a part of the adhesive layer 5 in the Y-axis direction makes contact with the first rollers 51A. Accordingly, resistance force exerted by the adhesive layer 5 on the first rollers 51A during advancement can be reduced.

Each of the first rollers 51A is of a hollow cylindrical shape, and thus makes line contact with the adhesive layer 5. As compared to when polygonal-shaped limiting members are used and make surface contact with the adhesive layer 5, a contact area between the limiting members and the adhesive layer 5 can be reduced, and thus resistance force exerted by the adhesive layer 5 on the limiting members during advancement can be reduced. Each of the first rollers 51A may be of a solid cylindrical shape, and thus makes line contact with the adhesive layer 5. Accordingly, a similar effect to the above can be obtained in this case as well.

The second rollers 51B are examples of isolation members that advance in conjunction with the blades 31 and support the adhesive layer 5 from below, behind limiting members (such as the first rollers 51A), so as to prevent re-adhesion of the adhesive layer 5 to the transparent plate 2.

Because the second rollers 51B advance in conjunction with the blades 31, the deformation of the display device 3 and the adhesive layer 5 due to their own weights can be maintained constant from the first rollers 51A to the second rollers 51B. As a result, re-adhesion of the adhesive layer 5 to the transparent plate 2 can be prevented.

As illustrated in FIG. 2B, the plurality of second rollers 51B are arranged at intervals in the Y-axis direction, and the plurality of second rollers 51B form a second roller group 50B. As neighboring second rollers 51B are spaced apart from each other, only a part of the adhesive layer 5 in the Y-axis direction makes contact with the second rollers 51B. Accordingly, resistance force exerted by the adhesive layer 5 on the second rollers 51B during advancement can be reduced.

Each of the second rollers 51B is of a hollow cylindrical shape, and thus makes line contact with the adhesive layer 5. As compared to when polygonal-shaped isolation members are used and make surface contact with the adhesive layer 5, a contact area between the isolation members and the adhesive layer 5 can be reduced, and thus resistance force exerted by the adhesive layer 5 on the isolation members during advancement can be reduced. Each of the second rollers 51B may be of a solid cylindrical shape, and thus make line contact with the adhesive layer 5. Accordingly, a similar effect to the above can be obtained in this case as well.

If the blades 31 are inserted between the adhesive layer 5 and the display device 3, the second rollers 51B are used as isolation members that advance in conjunction with the blades 31 and support the display device 3 from below, behind the limiting members (such as the first rollers 51A), so as to prevent re-adhesion of the adhesive layer 5 to the display device 3.

The third rollers 51C are examples of isolation members that advance in conjunction with the blades 31 and support the adhesive layer 5 from below, behind the limiting members (such as the first rollers 51A), so as to prevent re-adhesion of the adhesive layer 5 to the transparent plate 2. The third rollers 51C are disposed behind the second rollers 51B.

Because the third rollers 51C advance in conjunction with the blades 31, the deformation of the display device 3 and the adhesive layer 5 due to their own weights can be maintained constant from the second rollers 51B to the third rollers 51C. As a result, re-adhesion of the adhesive layer 5 to the transparent plate 2 can be prevented.

As illustrated in FIG. 2B, the plurality of third rollers 51C are arranged at intervals in the Y-axis direction, and the plurality of third rollers 51C form a third roller group 50C. As neighboring second rollers 51B are spaced apart from each other, only a part of the adhesive layer 5 in the Y-axis direction makes contact with the third rollers 51C. Accordingly, resistance force exerted by the adhesive layer 5 on the third rollers 51C during advancement can be reduced.

Each of the third rollers 51C is of a hollow cylindrical shape, and thus makes line contact with the adhesive layer 5. As compared to when polygonal-shaped isolation members are used and make surface contact with the adhesive layer 5, a contact area between the isolation members and the adhesive layer 5 can be reduced, and thus resistance force exerted by the adhesive layer 5 on the isolation members during advancement can be reduced. Each of the third rollers 51C may be of a solid cylindrical shape, and thus makes line contact with the adhesive layer 5. Accordingly, a similar effect to the above can be obtained in this case as well.

If the blades 31 are inserted between the adhesive layer 5 and the display device 3, the third rollers 51C are used as isolation members that advance in conjunction with the blades 31 and support the display device 3 from below, behind the limiting members (such as the first rollers 51A), so as to prevent re-adhesion of the adhesive layer 5 to the display device 3.

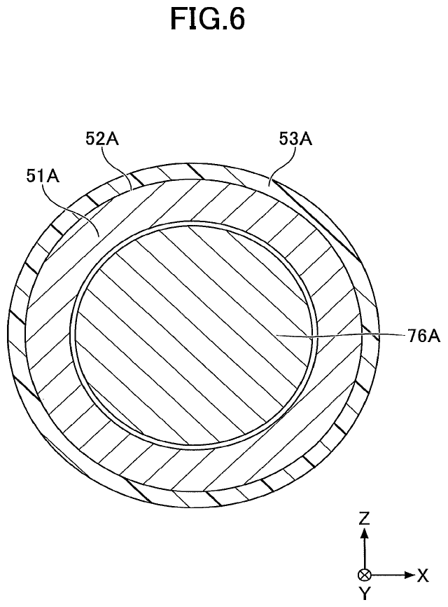

FIG. 6 is a cross-sectional view of a first roller according to the embodiment. A cross-sectional view of a second roller 51B and a cross-sectional view of a third roller 51C are the same as the cross-sectional view of the first roller illustrated in FIG. 6, and are thus not illustrated.

Each of the first rollers 51A has an outer peripheral curved surface 52A, and the curved surface 52A makes contact with the adhesive layer 5. Because the curved surface 52A makes contact with the adhesive layer 5, the curved surface 52A is roughened so as to reduce adherence to the adhesive layer 5. If the surface roughness Ra of the curved surface 52A is 0.5 μm or more, the adherence of the first rollers 51A to the adhesive layer 5 can be reduced, and the first rollers 51A can advance smoothly. Preferably, the surface roughness Ra of the curved surface 52A may be 0.8 μm or more. Further, in terms of workability the surface roughness Ra of the curved surface 52A may be 50 μm or less.

The outer peripheral curved surface 52A of each of the first rollers 51A makes contact with the adhesive layer 5 as described above. Therefore, a coating film 53A may be formed on the curved surface 52A. The coating film 53A is formed of a material having a water contact angle greater than that of a material of the first rollers 51A, thus improving the removability of the first rollers 51A from the adhesive layer 5. Accordingly, the first rollers 51A can advance smoothly. For example, the first rollers 51A are formed of a material such as metal or ceramic. Further, the coating film 53A is formed of a material such as silicone-based resin or fluorine-based resin, for example.

The thickness of the coating film 53A may be greater than or equal to 2 μm and less than or equal to 200 μm, for example. If the thickness of the coating film 53A is 2 μm or more, the coating film 53A is not readily torn, and thus has good durability. Further, if the thickness of the coating film 53A is 200 μm or less, the surface of the coating film 53A conforms to the roughened curved surface 52A. Thus, the coating film 53A has the same surface roughness Ra as that of the curved surface 52A.

It should be noted that the outer peripheral curved surface of each of the second rollers 51B and the outer peripheral curved surface of each of the third rollers 51C may also be roughened and coated. This is because the outer peripheral curved surfaces of the second rollers 51B and of the third rollers 51C make contact with the adhesive layer 5.

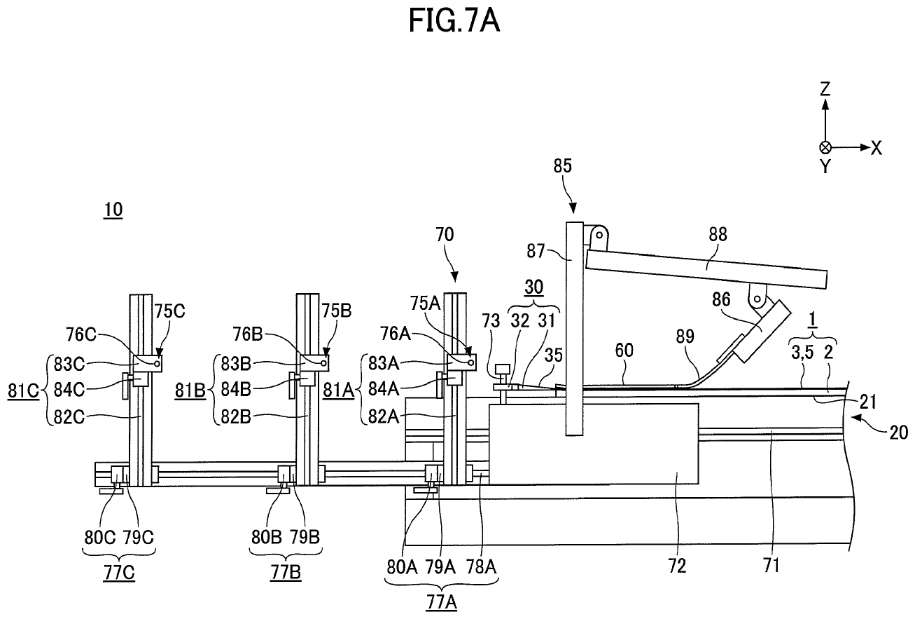

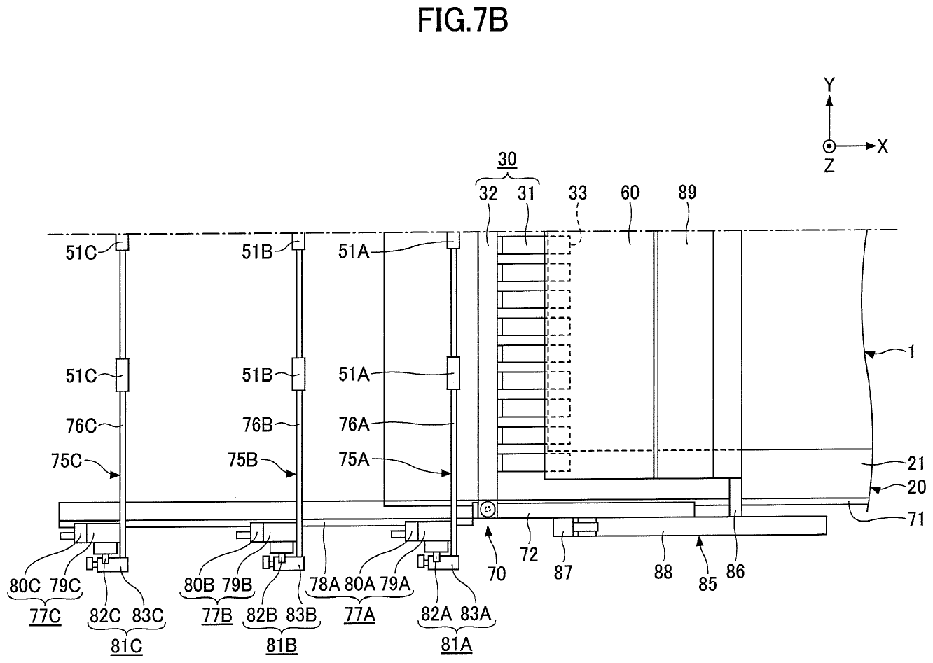

FIG. 7A is an enlarged view of a part of the separation apparatus illustrated in FIG. 2A. FIG. 7B is an enlarged view of a part of the separation apparatus illustrated in FIG. 2B. As illustrated in FIG. 7B, the heater 60 having a sheet shape makes contact with the display device 3 from above and heats the adhesive layer 5 from above, at least ahead of the blade tips 33. The adhesive layer 5 is softened when heated, and thus readily deforms when the blades 31 advance.

As with the display device 3, the heater 60 has the rectangular shape when viewed in the Z-axis direction as illustrated in FIG. 7B. The dimension in the Y-axis direction of the heater 60 is greater than the dimension in the Y-axis direction of the display device 3. The heater 60 entirely heats the display device 3 in the Y-axis direction. The dimension in the X-axis direction of the heater 60 is smaller than the dimension the X-axis direction of the display device 3, and the heater 60 only partially heats the display device 3 in the X-axis direction.

As the heater 60 has flexibility, the heater 60 may be deformed so as to move onto the inclined surfaces 35 of the blades 31 as illustrated in FIG. 7A. Accordingly, as illustrated in FIG. 7B, the heater 60 may make contact with the display device 3 from above, behind the blade tips 33 as well. The heater 60 may be a silicon rubber heater, for example.

The temperature of the heater 60 may be between greater than or equal to 40° C. and less than or equal to 230° C., but is not particularly limited thereto.

The interlocking mechanism 70 causes the first rollers 51A, the second rollers 51B, the third rollers 51C, and the heater 60 to advance in conjunction with the blades 31. The interlocking mechanism 70 may at least cause the first rollers 51A to advance in conjunction with the blades 31. In the following, details of the interlocking mechanism 70 will be described with reference to FIG. 7A and FIG. 7B.

The interlocking mechanism 70 includes a pair of guides 71 and a pair of sliders 72. The pair of guides 71 and the pair of sliders 72 are disposed at intervals in the Y-axis direction. The guides 71 are fixed to the base 20, and are disposed in parallel to the X-axis direction. The sliders 72 slide along the guides 71 in the X-axis direction. The blade holder 32 extends between the pair of the sliders 72, and slides together with the sliders 72 in the X-axis direction. As a result, the blades 31 move forward or backward in X-axis direction.

The interlocking mechanism 70 further includes a pair of height adjustment pins 73. The height adjustment pins 73 are provided for the respective sliders 72, and are disposed in parallel to the Z-axis direction. The blade holder 32 has a pair of through-holes that pass through the blade holder 32 in the Z-axis direction. The height adjustment pins 73 are inserted into the through-holes. The pair of through-holes is formed in correspondence with the pair of height adjustment pins 73. The blade holder 32 slides along the height adjustment pins 73 in the Z-axis direction. As a result, the height of the blades 31 relative to the support surface 21 of the base 20 can be adjusted. The height of the blades 31 is determined in accordance with the thickness of the transparent plate 2.

The interlocking mechanism 70 includes a first rotation support mechanism 75A, and the first rotation support mechanism 75A rotatably supports the first rollers 51A. Because the first rollers 51A are rotatable, the first rollers 51A advance while rotating. The rotation of the first rollers 51A causes the adhesive layer 5 to move backward relative to the first rollers 51A. Generally, rolling resistance is significantly smaller than sliding resistance. Thus, the first rollers 51A can advance smoothly, as compared to when the first rollers 51A do not rotate.

The first rotation support mechanism 75A includes a first rotation shaft 76A, for example. The first rotation shaft 76A rotatably supports the first rollers 51A. The first rollers 51A have through-holes that pass through the first rollers 51A in the Y-axis direction. The first rotation shaft 76A is inserted into the through-holes. The first rotation shaft 76A rotatably supports the cylindrical-shaped first rollers 51A from the radially inner side.

The first rotation shaft 76A may rotate together with the first rollers 51A. However, in the present embodiment, the first rotation shaft 76A does not rotate together with the first rollers 51A. Because the first rotation shaft 76A does not rotate, the moment of inertia is small, and the first rollers 51A readily rotate. Further, because the first rotation shaft 76A does not rotate, the plurality of first rollers 51A can independently rotate.

If the first rotating shaft 76A rotates together with the first rollers 51A, the first rotation support mechanism 75A may further include bearings. The bearings rotatably support the first rotation shaft 76A and rotatably support the first rollers 51A.

The interlocking mechanism 70 includes a first distance adjustment mechanism 77A. The first distance adjustment mechanism 77A adjusts a first distance LA (see FIG. 5) between the blade tips 33 and the first rollers 51A in the moving direction of the blades 31 (in the X-axis direction). The first distance LA is, for example, a distance from the blade tips 33 to the center of the first rollers 51A in the X-axis direction.

The first distance LA is determined in accordance with the thickness of the display device 3, for example. As the display device 3 becomes thinner, the bending stiffness of the display device 3 becomes smaller. Thus, the display device 3 tends to hang down, causing the adhesive layer 5 to readily make contact with the blades 31. Accordingly, the thinner the display device 3 is, the smaller the first distance LA is set. This is because the smaller the first distance LA is, the less the display device 3 hangs down. The first distance LA may be greater than or equal to 20 mm and less than or equal to 280 mm, but is not particularly limited thereto.

The first distance adjustment mechanism 77A includes, for example, a pair of first distance adjustment guides 78A, a pair of first distance adjustment sliders 79A, and a pair of first distance adjustment clamps 80A. The first distance adjustment guides 78A, the first distance adjustment sliders 79A, and the first distance adjustment clamps 80A are disposed at intervals in the Y-axis direction.

The first distance adjustment guides 78A are fixed to the sliders 72, and are disposed in parallel to the X-axis direction. The first distance adjustment sliders 79A slide along the first distance adjustment guides 78A in the X-axis direction behind the sliders 72. The blades 31 move in the X-axis direction together with the sliders 72. The first rollers 51A move in the X-axis direction together with the first distance adjustment sliders 79A.

The first distance adjustment clamps 80A move in the X-axis direction along the first distance adjustment guides 78A together with the first distance adjustment sliders 79A. The first distance adjustment clamps 80A clamp the first distance adjustment guides 78A at desired positions, such that the first distance adjustment sliders 79A are stopped with respect to the first distance adjustment guides 78A. The first distance LA is determined based on positions at which the first distance adjustment sliders 79A are stopped.

When the first rollers 51A advance in conjunction with the blades 31, the first distance adjustment clamps 80A clamp the first distance adjustment guides 78A. As the clamping force, an elastic restoring force from an elastic body such as a spring, hydraulic pressure, or pneumatic pressure may be used. When the first distance LA is adjusted, the first distance adjustment clamps 80A unclamp the first distance adjustment guides 78A. The first distance adjustment guides 78A may be clamped or unclamped manually or by a driving force such as a motor or a hydraulic cylinder.

When the first distance LA is adjusted, the first distance adjustment sliders 79A are moved in the X-axis direction along the first distance adjustment guides 78A. The first distance adjustment sliders 79A may be moved manually or by a driving force such as a motor or a hydraulic cylinder. The plurality of first rollers 51A move in the X-axis direction together with the first distance adjustment sliders 79A, thus allowing the first distance LA to be adjusted. The first rollers 51A simultaneously move in the X-axis direction, and are positioned at the same first distance LA.

It should be noted that the configuration of the first distance adjustment mechanism 77A is not limited to the above-described configuration. For example, the first rollers 51A may move in the X-axis direction together with the sliders 72, and the blades 31 may move in the X-axis direction together with the first distance adjustment sliders 79A. In this case, the first distance adjustment sliders 79A and the sliders 72 are replaced with each other, and the first distance adjustment sliders 79A slide along the first distance adjustment guides 78A in the X-axis direction, ahead of the sliders 72.

The interlocking mechanism 70 includes a first height adjustment mechanism 81A. The first height adjustment mechanism 81A adjusts a first height HA (see FIG. 5) of the first rollers 51A relative to the support surface 21 of the base 20. The first height HA is, for example, a height at which the adhesive layer 5 is lifted by the first rollers 51A from the transparent plate 2.

Similar to the first distance LA, the first height HA is determined in accordance with the thickness of the display device 3, for example. As the display device 3 becomes thinner, the bending stiffness of the display device 3 becomes smaller. Thus, the display device 3 tends to hang down, causing the adhesive layer 5 to readily make contact with the blades 31. Accordingly, the thinner the display device 3 is, the greater the first height HA is set. The first height HA may be greater than or equal to 5 mm and less than or equal to 100 mm, but is not particularly limited thereto.

The first height adjustment mechanism 81A includes, for example, a pair of first height adjustment guides 82A, a pair of first height adjustment sliders 83A, and a pair of first height adjustment clamps 84A. The first height adjustment guides 82A, the first height adjustment sliders 83A, and the first height adjustment clamps 84A are disposed at intervals in the Y-axis direction.

The first height adjustment guides 82A are fixed to the first distance adjustment sliders 79A, for example, and are disposed in parallel to the Z-axis direction. The first height adjustment sliders 83A slide along the first height adjustment guides 82A in the Z-axis direction. The first rollers 51A move in the Z-axis direction together with the first height adjustment sliders 83A.

The first height adjustment clamps 84A move in the Z-axis direction along the first height adjustment guides 82A together with the first height adjustment sliders 83A. The first height adjustment clamps 84A clamp the first height adjustment guides 82A at desired positions, such that the first height adjustment sliders 83A are stopped with respect to the first height adjustment guides 82A. The first height HA is determined based on positions at which the first height adjustment sliders 83A are stopped.

When the first rollers 51A advance in conjunction with the blades 31, the first height adjustment clamps 84A clamp the first height adjustment guides 82A. As the clamping force, an elastic restoring force from an elastic body such as a spring, hydraulic pressure, or pneumatic pressure may be used. When the first height HA is adjusted, the first height adjustment clamps 84A unclamp the first height adjustment guides 82A. The first height adjustment guides 82A may be clamped or unclamped manually or by a driving force such as a motor or a hydraulic cylinder.

When the first height HA is adjusted, the first height adjustment sliders 83A are moved in the Z-axis direction along the first height adjustment guides 82A. The first height adjustment sliders 83A may be moved manually or by a driving force such as a motor or a hydraulic cylinder. The plurality of first rollers 51A move in the Z-axis direction together with the first height adjustment sliders 83A, thus allowing the first height HA to be adjusted. The first rollers 51A simultaneously move in the Z-axis direction, and are positioned at the same first height HA.

It should be noted that the configuration of the first height adjustment mechanism 81A is not limited to the above-described configuration. For example, the first rollers 51A may move in the X-axis direction together with the sliders 72, and the blades 31 may move in the X-axis direction together with the first distance adjustment sliders 79A. In this case, the first distance adjustment sliders 79A and the sliders 72 are replaced with each other, and the first height adjustment guides 82A are fixed to the sliders 72.

Further, in the present embodiment, the first height HA is fixed during advancement of the blades 31; however, the first height HA may be adjusted during advancement of the blades 31. As the blades 31 advance, an area in which the adhesive layer 5 has not been separated becomes small, thereby resulting in stress concentration. In order to avoid excessive stress, the first height HA may be adjusted to become smaller continuously or stepwise, as the blades 31 advance.

The interlocking mechanism 70 includes a second rotation support mechanism 75B, and the second rotation support mechanism 75B rotatably supports the second rollers 51B. Because the second rollers 51B are rotatable, the second rollers 51B advance while rotating. The rotation of the second rollers 51B causes the adhesive layer 5 to move backward relative to the second rollers 51B. Generally, rolling resistance is significantly smaller than sliding resistance. Thus, the second rollers 51B can advance smoothly, as compared to when the second rollers 51B do not rotate.

The second rotation support mechanism 75B includes a second rotation shaft 76B, for example. The second rotation shaft 76B rotatably supports the second rollers 51B. The second rollers 51B have through-holes that pass through the second rollers 51B in the Y-axis direction. The second rotation shaft 76B is inserted into the through-holes. The second rotation shaft 76B rotatably supports the cylindrical-shaped second rollers 51B from the radially inner side.

The second rotation shaft 76B may rotate together with the second rollers 51B. However, in the present embodiment, the second rotation shaft 76B does not rotate together with the second rollers 51B. Because the second rotation shaft 76B does not rotate, the moment of inertia is small, and the second rollers 51B readily rotate. Further, because the second rotation shaft 76B does not rotate, the plurality of second rollers 51B can independently rotate.

If the second rotation shaft 76B rotates together with the second rollers 51B, the second rotation support mechanism 75B may further include bearings. The bearings rotatably support the second rotation shaft 76B and rotatably support the second rollers 51B.

The interlocking mechanism 70 includes a second distance adjustment mechanism 77B. The second distance adjustment mechanism 77B adjusts a second distance LB (see FIG. 5) between the blade tips 33 and the second rollers 51B in the moving direction (the X-axis direction) of the blades 31. The second distance LB is, for example, a distance from the blade tips 33 to the center of the second rollers 51B in the X-axis direction.

The second distance LB is determined in accordance with the thickness of the display device 3, for example. As the display device 3 becomes thinner, the bending stiffness of the display device 3 becomes smaller. Thus, the display device 3 tends to hang down, causing the adhesive layer 5 to readily re-adhere to the transparent plate 2. Accordingly, the thinner the display device 3 is, the smaller the second distance LB is set. This is because the smaller the second distance LB is, the less the display device 3 hangs down. The second distance LB may be greater than or equal to 300 mm and less than or equal to 700 mm, but is not particularly limited thereto.

Similar to the first distance adjustment mechanism 77A, the second distance adjustment mechanism 77B includes, for example, a pair of second distance adjustment sliders 79B, and a pair of second distance adjustment clamps 80B. The second distance adjustment sliders 79B and the second distance adjustment clamps 80B are disposed at intervals in the Y-axis direction.

The second distance adjustment sliders 79B slide along the first distance adjustment guides 78A in the X-axis direction behind the sliders 72 and the first distance adjustment sliders 79A. The first distance adjustment guides 78A guide not only the first distance adjustment sliders 79A, but also the second distance adjustment sliders 79B. However, the second distance adjustment sliders 79B may be provided with dedicated guides. In any case, the second rollers 51B move in the X-axis direction together with the second distance adjustment sliders 79B.

The second distance adjustment clamps 80B move in the X-axis direction along the first distance adjustment guides 78A together with the second distance adjustment sliders 79B. The second distance adjustment clamps 80B clamp the first distance adjustment guides 78A at desired positions, such that the second distance adjustment sliders 79B are stopped with respect to the first distance adjustment guides 78A. The second distance LB is determined based on positions at which the second distance adjustment sliders 79B are stopped.

It should be noted that the configuration of the second distance adjustment mechanism 77B is not limited to the above-described configuration. For example, the second rollers 51B may move in the X-axis direction together with the sliders 72, and the blades 31 may move in the X-axis direction together with the second distance adjustment sliders 79B. In this case, the second distance adjustment sliders 79B and the sliders 72 are replaced with each other, and the second distance adjustment sliders 79B slide along the first distance adjustment guides 78A in the X-axis direction, ahead of the sliders 72.

The interlocking mechanism 70 includes a second height adjustment mechanism 81B. The second height adjustment mechanism 81B adjusts a second height HB (see FIG. 5) of the second rollers 51B relative to the support surface 21 of the base 20. The second height HB is, for example, a height at which the adhesive layer 5 is lifted by the second rollers 51B from the transparent plate 2.

Similar to the second distance LB, the second height HB is determined in accordance with the thickness of the display device 3, for example. As the display device 3 becomes thinner, the bending stiffness of the display device 3 becomes smaller. Thus, the display device 3 tends to hang down, causing the adhesive layer 5 to readily re-adhere to the transparent plate 2. Accordingly, the thinner the display device 3 is, the greater the second height HB is set. The second height HB may be greater than or equal to 20 mm and less than or equal to 200 mm, but is not particularly limited thereto.

The second height adjustment mechanism 81B includes, for example, a pair of second height adjustment guides 82B, a pair of second height adjustment sliders 83B, and a pair of second height adjustment clamps 84B. The second height adjustment guides 82B, the second height adjustment sliders 83B, and the second height adjustment clamps 84B are disposed at intervals in the Y-axis direction.

The second height adjustment guides 82B are fixed to the second distance adjustment sliders 79B, for example, and are disposed in parallel to the Z-axis direction. The second height adjustment sliders 83B slide along the second height adjustment guides 82B in the Z-axis direction. The second rollers 51B move in the Z-axis direction together with the second height adjustment sliders 83B.

The second height adjustment clamps 84B move in the Z-axis direction along the second height adjustment guides 82B together with the second height adjustment sliders 83B. The second height adjustment clamps 84B clamp the second height adjustment guides 82B at desired positions, such that the second height adjustment sliders 83B are stopped with respect to the second height adjustment guides 82B. The second height HB is determined based on positions at which the second height adjustment sliders 83B are stopped.

It should be noted that the configuration of the second height adjustment mechanism 81B is not limited to the above-described configuration. For example, as described above, the second rollers 51B may move in the X-axis direction together with the sliders 72, and the blades 31 may move in the X-axis direction together with the second distance adjustment sliders 79B. In this case, the second distance adjustment sliders 79B and the sliders 72 are replaced with each other, and the second height adjustment guides 82B are fixed to the sliders 72.

The interlocking mechanism 70 includes a third rotation support mechanism 75C, and the third rotation support mechanism 75C rotatably supports the third rollers 51C. Because the third rollers 51C are rotatable, the third rollers 51C advance while rotating. The rotation of the third rollers 51C causes the adhesive layer 5 to move backward relative to the third rollers 51C. Generally, rolling resistance is significantly smaller than sliding resistance. Thus, the third rollers 51C can advance smoothly, as compared to when the third rollers 51C do not rotate.

The third rotation support mechanism 75C includes a third rotation shaft 76C, for example. The third rotation shaft 76C rotatably supports the third rollers 51C. The third rollers 51C have through-holes that pass through the third rollers 51C in the Y-axis direction. The third rotation shaft 76C is inserted into the through-holes. The third rotation shaft 76C rotatably supports the cylindrical-shaped third rollers 51C from the radially inner side.

The third rotation shaft 76C may rotate together with the third rollers 510. However, in the present embodiment, the third rotation shaft 76C does not rotate together with the third rollers 51C. Because the third rotation shaft 76C does not rotate, the moment of inertia is small, and the third rollers 51C readily rotate. Further, because the third rotation shaft 76C does not rotate, the plurality of third rollers 51C can independently rotate.

If the third rotation shaft 76C rotates together with the third rollers 510, the third rotation support mechanism 75C may further include bearings. The bearings rotatably support the third rotation shaft 76C and rotatably support the third rollers 51C.

The interlocking mechanism 70 includes a third distance adjustment mechanism 77C. The third distance adjustment mechanism 77C adjusts a third distance LC (see FIG. 5) between the blade tips 33 and the third rollers 51C in the moving direction of the blades 31 (in the X-axis direction). The third distance LC is, for example, a distance from the blade tips 33 to the center of the third rollers 510 in the X-axis direction.

The third distance LC is determined in accordance with the thickness of the display device 3, for example. As the display device 3 becomes thinner, the bending stiffness of the display device 3 becomes smaller. Thus, the display device 3 tends to hang down, causing the adhesive layer 5 to readily re-adhere to the transparent plate 2. Accordingly, the thinner the display device 3 is, the smaller the third distance LC is set. This is because the smaller the third distance LC is, the less the display device 3 hangs down. The third distance LC may be greater than or equal to 500 mm and less than or equal to 1,500 mm, but is not particularly limited thereto.

Similar to the first distance adjustment mechanism 77A, the third distance adjustment mechanism 77C includes, for example, a pair of third distance adjustment sliders 79C, and a pair of third distance adjustment clamps 80C. The third distance adjustment sliders 79C and the third distance adjustment clamps 80C are disposed at intervals in the Y-axis direction.

The third distance adjustment sliders 79C slide along the first distance adjustment guides 78A in the X-axis direction behind the sliders 72, the first distance adjustment sliders 79A, and the second distance adjustment sliders 79B. The first distance adjustment guides 78A guide not only the first distance adjustment sliders 79A, but also the third distance adjustment sliders 79C. However, the third distance adjustment sliders 79C may be provided with dedicated guides. In any case, the third rollers 51C move in the X-axis direction together with the third distance adjustment sliders 79C.

The third distance adjustment clamps 80C move in the X-axis direction along the first distance adjustment guides 78A together with the third distance adjustment sliders 79C. The third distance adjustment clamps 80C clamp the first distance adjustment guides 78A at desired positions, such that the third distance adjustment sliders 79C are stopped with respect to the first distance adjustment guides 78A. The third distance LC is determined based on positions at which the third distance adjustment sliders 79C are stopped.

It should be noted that the configuration of the third distance adjustment mechanism 77C is not limited to the above-described configuration. For example, the third rollers 51C may move in the X-axis direction together with the sliders 72, and the blades 31 may move in the X-axis direction together with the third distance adjustment sliders 79C. In this case, the third distance adjustment sliders 79C and the sliders 72 are replaced with each other, and the third distance adjustment sliders 79C slide along the first distance adjustment guides 78A in the X-axis direction, ahead of the sliders 72.

The interlocking mechanism 70 includes a third height adjustment mechanism 81C. The third height adjustment mechanism 81C adjusts a third height HC (see FIG. 5) of the third rollers 51C relative to the support surface 21 of the base 20. The third height HC is, for example, a height at which the adhesive layer 5 is lifted by the third rollers 51C from the transparent plate 2.

Similar to the third distance LC, the third height HC is determined in accordance with the thickness of the display device 3, for example. As the display device 3 becomes thinner, the bending stiffness of the display device 3 becomes smaller. Thus, the display device 3 tends to hang down, causing the adhesive layer 5 to readily re-adhere to the transparent plate 2. Accordingly, the thinner the display device 3 is, the greater the third height HC is set. The third height HC may be greater than or equal to 20 mm and less than or equal to 200 mm, but is not particularly limited thereto.

The third height adjustment mechanism 81C includes, for example, a pair of third height adjustment guides 82C, a pair of third height adjustment sliders 83C, and a pair of third height adjustment clamps 84C. The third height adjustment guides 82C, the third height adjustment sliders 83C, and the third height adjustment clamps 84C are disposed at intervals in the Y-axis direction.

The third height adjustment guides 82C are fixed to the third distance adjustment sliders 79C, for example, and are disposed in parallel to the Z-axis direction. The third height adjustment sliders 83 slide along the third height adjustment guides 82C in the Z-axis direction. The third rollers 51C move in the Z-axis direction together with the third height adjustment sliders 83C.

The third height adjustment clamps 84C move in the Z-axis direction along the third height adjustment guides 82C together with the third height adjustment sliders 83C. The third height adjustment clamps 84C clamp the third height adjustment guides 82C at desired positions, such that the third height adjustment sliders 83C are stopped with respect to the third height adjustment guides 82C. The third height HC is determined based on positions at which the third height adjustment sliders 83C are stopped.

It should be noted that the configuration of the third height adjustment mechanism 81C is not limited to the above-described configuration. For example, as described above, the third rollers 51C may move in the X-axis direction together with the sliders 72, and the blades 31 may move in the X-axis direction together with the third distance adjustment sliders 79C. In this case, the third distance adjustment sliders 79C and the sliders 72 are replaced with each other, and the third height adjustment guides 82C are fixed to the sliders 72.

The interlocking mechanism 70 includes a heater support mechanism 85. The heater support mechanism 85 causes the heater 60 to advance in conjunction with the blades 31. Because the heater 60 advances in conjunction with the blades 31, it is possible to prevent unnecessary heating far behind a separation area, while also preventing unnecessary heating far ahead of the separation area. Further, the power consumption of the heater 60 can be reduced, allowing the capacity of the power supply to be reduced.

The heater support mechanism 85 includes a heater holder 86. The heater holder 86 is located ahead of the heater 60 and advances together with the heater 60. The heater holder 86 causes the heater 60 to slide forward while keeping the heater 60 in contact with the display device 3. Unlike a case where the heater 60 is pushed forward from behind, tension can be applied to the heater 60, thus preventing the generation of wrinkles on the heater 60, and also facilitating heat transfer from the heater 60 to display device 3.

The heater support mechanism 85 includes a pair of support columns 87 disposed spaced apart from each other in the Y-axis direction, and a pair of support arms 88 disposed spaced apart from each other in the Y-axis direction. The support columns 87 are fixed to the sliders 72. The support arms 88 extend forward of the support columns 87, and support the heater holder 86 ahead of the heater 60. The heater holder 86 extends between the pair of support arms 88, and advances together with the sliders 72.

The heater holder 86 is more rigid than the heater 60. Thus, in order not to damage the display device 3, the heater holder 86 is disposed spaced apart from the display device 3. The heater support mechanism 85 includes a flexible sheet 89, and the flexible sheet 89 couples the heater holder 86 to the heater 60. Because the flexible sheet 89 bends, the heater 60 makes contact with the display device 3 entirely in the X-axis direction, allowing heat from the heater 60 to be efficiently transmitted to the display device 3. It should be noted that the flexible sheet 89 has insulation properties and does not generate heat.

Although the embodiments have been described above, the present invention is not limited to the above-described embodiments. Variations, modifications, substitutions, additions, omissions, and combinations can be made to the described subject matter without departing from the scope of the present invention, and it is to be understood that such variations, modifications, substitutions, additions, omissions, and combinations obviously belong in the technical scope of the present invention.

1. A separation apparatus for separating a first plate from a laminate comprising the first plate, an adhesive layer, and a second plate, comprising:
a base configured to flatly support the first plate from below such that the second plate is disposed above the first plate;
a blade configured to be inserted between the first plate and the adhesive layer and to advance in parallel to a support surface of the base that supports the first plate;
a limiting member configured to support the adhesive layer from below and to limit contact between the adhesive layer and the blade such that the limiting member is behind a blade tip that is a front end of the blade; and
an interlocking mechanism configured to cause the limiting member to advance in conjunction with the blade,
wherein the laminate is formed by laminating the first plate, the adhesive layer, and the second plate in an order of the first plate, the adhesive layer, and the second plate.

2. The separation apparatus according to claim 1, further comprising:
an isolation member configured to advance in conjunction with the blade, support the adhesive layer from below, and prevent re-adhesion of the adhesive layer to the first plate such that the isolation member is behind the limiting member.

3. A separation apparatus for separating a second plate from a laminate comprising a first plate, an adhesive layer, and the second plate, comprising:
a base configured to flatly support the first plate from below such that the second plate is disposed above the first plate;
a blade configured to be inserted between the second plate and the adhesive layer and to advance in parallel to a support surface of the base that supports the first plate;
a limiting member configured to support the second plate from below and to limit contact between the second plate and the blade such that the limiting member is behind a blade tip that is a front end of the blade; and
an interlocking mechanism configured to cause the limiting member to advance in conjunction with the blade,
wherein the laminate is formed by laminating the first plate, the adhesive layer, and the second plate in an order of the first plate, the adhesive layer, and the second plate.

4. The separation apparatus according to claim 3, further comprising:
an isolation member configured to advance in conjunction with the blade, support the second plate from below, and prevent re-adhesion of the second plate to the adhesive layer such that the isolation member is behind the limiting member.

5. The separation apparatus according to claim 1, wherein the limiting member is a roller that is formed in a hollow cylindrical shape or a solid cylindrical shape.

6. The separation apparatus according to claim 5, wherein the interlocking mechanism includes a rotation support mechanism configured to rotatably support the roller.

7. The separation apparatus according to claim 1, wherein the limiting member is formed in a plurality such that the plurality of limiting members are disposed at intervals in a direction perpendicular to a moving direction of the blade and are parallel to the support surface of the base.

8. The separation apparatus according to claim 1, wherein the interlocking mechanism includes a distance adjustment mechanism configured to adjust a distance between the blade tip and the limiting member.

9. The separation apparatus according to claim 1, wherein the interlocking mechanism includes a height adjustment mechanism configured to adjust a height of the limiting member relative to the support surface of the base.

10. The separation apparatus according to claim 1, further comprising:
a sheet-shaped heater configured to make contact with the second plate from above and heat the adhesive layer from above at least ahead of the blade tip,
wherein the interlocking mechanism includes a heater support mechanism configured to cause the heater to advance in conjunction with the blade.

11. The separation apparatus according to claim 10, wherein the heater support mechanism includes a heater holder provided ahead of the heater, and configured to advance together with the heater.

12. The separation apparatus according to claim 11, wherein the heater holder is disposed apart from the second plate, and the heater support mechanism includes a flexible sheet that couples the heater holder to the heater.

13. The separation apparatus according to claim 1, wherein the blade is formed in a plurality such that the plurality of blades are disposed at intervals in a direction perpendicular to a moving direction of the plurality of blades and are parallel to the support surface of the base.

14. The separation apparatus according to claim 1, wherein the second plate is a display device that displays an image.

15. The separation apparatus according to claim 14, wherein the first plate is a transparent plate that protects an image display surface of the display device, and the adhesive layer is transparent.

16. A blade unit for separating a first plate from a laminate comprising the first plate, an adhesive layer, and a second plate, comprising:
a blade comprising a blade tip configured to be inserted between the first plate and the adhesive layer, and a parallel surface configured to advance in parallel to a support surface of a base that supports the first plate; and
a coating film formed on at least a part of a surface of the blade such that the coating film comes into contact with the adhesive layer,
wherein the laminate is formed by laminating the first plate, the adhesive layer, and the second plate in an order of the first plate, the adhesive layer, and the second plate.

17. A blade unit for separating a second plate from a laminate comprising a first plate, an adhesive layer, and the second plate, comprising:
a blade comprising a blade tip configured to be inserted between the second plate and the adhesive layer, and a parallel surface configured to advance in parallel to a support surface of a base that supports the first plate; and
a coating film formed on at least a part of a surface of the blade such that the coating film comes into contact with the adhesive layer,
wherein the laminate is formed by laminating the first plate, the adhesive layer, and the second plate in an order of the first plate, the adhesive layer, and the second plate.

18. The blade unit according to claim 16, wherein the blade has the blade tip having a blade tip angle of greater than or equal to 1° and less than or equal to 60°.

19. The blade unit according to claim 16, wherein the coating film includes silicone-based resin.

20. The blade unit according to claim 16, wherein the at least part of the surface of the blade has surface roughness Ra of 0.7 μm or more.
